(19) United States
(12) Patent Application Publication
(10) Pub. No.: US 2007/0233720 A1
(43) Pub. Date: Oct. 4, 2007

(54) LAZY BULK INSERTION METHOD FOR MOVING OBJECT INDEXING

(75) Inventors: Hae Young BAE, Incheon (KR); Young Hwan OH, Gyeonggi-do (KR); Ho Seok KIM, Gyeonggi-do (KR); Yong Il JANG, Incheon (KR); Byeong Seob YOU, Gyeonggi-do (KR); Sang Hun EO, Seoul (KR); Dong Wook LEE, Seoul (KR); John Hyeon CHEON, Seoul (KR)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(73) Assignee: INHA-INDUSTRY PARTNERSHIP INSTITUTE, Incheon (KR)

(21) Appl. No.: 11/611,284

(22) Filed: Dec. 15, 2006

(30) Foreign Application Priority Data
Apr. 4, 2006 (KR) 10-2006-0030366

(51) Int. Cl. G06F 7/00

(52) U.S. Cl. 707/101

(57) ABSTRACT

The present invention relates to a lazy bulk insertion method for moving object indexing, which utilizes a hash-based data structure to overcome the disadvantages of an R-tree, and uses two buffers to simultaneously store operations in the buffers and process queries stored in the buffers, so that the overall update cost can be reduced. In the lazy bulk insertion method, a buffer is substituted and a state of the buffer is changed to a deactivated state if an input query cannot be stored in the buffer. Operations stored in the deactivated buffer are sequentially analyzed, information about objects corresponding to respective operations is obtained from a direct link to analyze the operations, and thus the operations are aligned on the basis of object IDs. Operations, aligned in ascending order of spatial objects, are identified depending on respective objects, effectiveness of the operations is determined, and thus the operations are realigned on the basis of terminal node IDs. The number of insert operations and the number of delete operations are counted for each terminal node, and variation in the number of empty spaces in the terminal node is obtained, thus splitting and merging of the terminal nodes is predicted. A processing sequence of queries is reorganized so as to reduce variation in the node on the basis of the predicted information.

### BACKGROUND OF THE INVENTION

1. Field of the Invention

The present invention relates, in general, to a method of indexing moving objects and, more particularly, to a lazy bulk insertion method for moving object indexing, which utilizes a hash-based data structure to overcome the disadvantages of an R-tree, and uses two buffers to simultaneously store operations in the buffers and process queries stored in the buffers, so that the overall update cost can be reduced, and which utilizes a buffer structure to process data about moving objects in a batch manner, so that all input queries about moving objects can be stored and managed.

2. Description of the Related Art

There are various technologies, such as moving object indexing techniques for processing location-based queries, managing information about the current locations of moving objects and processing queries about the current location information, and bulk insertion techniques for considering update loads on databases to efficiently handle a plurality of dynamic moving objects.

Of conventional moving object indexing techniques, there is no indexing technique that exhibits excellent performance for all location-based queries.

Generally, location-based queries related to the movement of moving objects are mainly classified into a range query, a timestamp query, a trajectory query, and a composite query. The range query is a query for searching for moving objects belonging to the spatial domain in a given time interval. The timestamp query is a query for searching for moving objects belonging to a given spatial domain at a specific time. The trajectory query is a query for searching for the trajectory of a moving object. The composite query is a query in which the range query for a space-time domain and the trajectory query are combined with each other.

Further, moving object indexing techniques based on location-based queries are mainly classified into three types. First, a past query is a query about past data, such as the data stored in a storage space. In order to support the past query, indexing must be implemented to store location information about a moving object at different respective times. If location information about a single object is updated, previous information is stored in a storage space along with temporal information. Second, a current query handles only information about the current location of a moving object. It is very complicated to handle a current query in a very dynamic environment provided by a location acquisition server, because, in order to respond the current query, the location acquisition server must have information about the latest locations of all moving objects. Finally, a future query handles the predicted location of a moving object. Additional information, such as information about a velocity or direction, must be transmitted from the moving object to a local server. A warning message in such a query must be given before an event occurs. A query about a current location must consider the insertion sequence of data in a linearly increasing time domain. Further, the distribution of moving objects dynamically varies with time, thus a dynamic index structure is required.

A representative index structure for moving objects includes an R-tree, a hashing technique, proposed to reduce update costs, a Lazy Update R (LUR)-tree, etc.

The R-tree has a hierarchical structure derived from a Balanced (B)-tree as a basic structure, and each node of the R-tree corresponds to the smallest d-dimensional rectangle, including a child node thereof. A terminal node includes a pointer for an actual geometrical object, instead of including a child node existing in a database. The R-tree is advantageous in that the location of a moving object can be represented by a two-dimensional point, and a fixed grid file can be indexed through a relatively simple procedure using a method of hashing the location of a moving object as a key value.

However, when an index structure is implemented using indices or when a data set has a non-uniform distribution, there is a problem in that continuous overflow is caused in a cell in a specific region, thus indexing performance is deteriorated. Moving objects frequently cause regions to become congested with moving objects due to the mobility thereof.

Further, since the R-tree is a height-balanced tree structure, it exhibits excellent performance, regardless of the distribution of data. However, since spatial indexing is designed based on static data, and an operation for varying indices, such as searching or insertion, is not separately defined, variation in indices occurs due to continuous change in the location of the moving object, and overall indexing performance is deteriorated due to the frequent change in indices.

Meanwhile, a hashing technique is a technique for utilizing hashing to solve the update problem of indices, which frequently occurs as the number of moving objects increases and as the locations of the moving objects dynamically change. The hashing technique is designed to divide an entire space into a certain number of grids, and to store only the IDs of grids to which objects belong in indices. The movement of objects within the grids to which the objects belong is not considered in the indices.

However, the congestion of moving objects in a hash-based indexing technique causes the overflow of cell buckets, and thus deteriorates indexing performance.

The LUR-tree technique was proposed to solve the problem in that a typical multi-dimensional index structure, such as the R-tree, incurs a high update cost to handle moving objects, which are continuously updated. If the new location of a moving object does not deviate from the range of the minimum Bounding Rectangle (MBR) of an existing terminal node, using a linear function so as to reduce the number of update operations, the update cost of the R-tree is greatly reduced by varying only the internal location of the node without changing the structure of the tree.

Bulk insertion is a technique for promptly adding bulk of new spatial data to a multi-dimensional spatial index structure. Conventional methods perform bulk insertion using a similar method. That is, the bulk data is inserted using a method of clustering the bulk data through spatial proximity, and inserting respective clusters into a target R-tree in bulk at one time while setting each cluster to a single unit.

Research into bulk insertion includes a Small-Tree-Large-Tree (STLT) technique for forming a single input R-tree (small tree) using input data and inserting the input R-tree into a target R-tree (large tree). Further, a method of utilizing the STLT includes a Generalized Bulk Insertion (GBI) technique for dividing an input data set into spatially approximate data groups to generate a plurality of clusters, generating R-trees from respective clusters, and inserting the R-trees into a target tree in bulk one at one time.

However, these techniques incur a high cost to cluster data, and have a wide overlapping region between existing R-tree nodes and newly inserted small tree nodes. In the R-tree, an overlapping region may exist between the MBRs of the nodes, and the performance of the R-tree varies according to the area of the overlapping region. As the area of the overlapping region increases, the number of nodes to be searched increases, thus the performance of processing of queries decreases. In bulk insertion, since a plurality of pieces of data is inserted at one time, insertion speed can be improved. However, the overlapping region between inserted clusters and an existing spatial index structure increases. Therefore, bulk insertion, having a wide overlapping region between nodes, is disadvantages in that insertion performance and search performance may be deteriorated.

### SUMMARY OF THE INVENTION

Accordingly, the present invention has been made keeping in mind the above problems occurring in the prior art, and an object of the present invention is to provide a lazy bulk insertion method for moving object indexing, which utilizes a hash-based data structure to overcome the disadvantages of an R-tree, that is, a representative spatial index structure, and uses two buffers to simultaneously store operations in the buffers and process queries stored in the buffers, so that the overall update cost can be reduced.

Another object of the present invention is to provide a lazy bulk insertion method for moving object indexing, which utilizes a buffer structure to process data about moving objects in a batch manner, so that all input queries about moving objects can be stored and managed.

In order to accomplish the above objects, the present invention provides a lazy bulk insertion method for a moving object indexing method based on an R-tree, comprising a first step of substituting a buffer and changing a state of the buffer to a deactivated state if an input query cannot be stored in the buffer; a second step of sequentially analyzing operations stored in the deactivated buffer, obtaining information about objects corresponding to respective operations from a direct link to analyze the operations, and thus aligning the operations on the basis of object IDs; a third step of identifying operations, aligned in ascending order of spatial objects, depending on respective objects, determining effectiveness of the operations, and thus realigning the operations on the basis of terminal node IDs; a fourth step of counting a number of insert operations and a number of delete operations for each terminal node, and obtaining variation in a number of empty spaces in the terminal node, thus predicting splitting and merging of the terminal nodes; and a fifth step of reorganizing a processing sequence of queries so as to reduce variation in the node on the basis of the predicted information.

Preferably, the second step may comprise a search operation step, an insert operation step, a delete operation step, and an update operation step.

Preferably, the search operation step may be performed so that values of an origin node and a result node are processed without being changed from initial values thereof, and result values of the processing are stored in the buffer.

Preferably, the insert operation step may comprise the steps of, if information about a terminal node exists in a result node of a direct link, obtaining a value indicating failure as a result of the operation, and considering the operation to have been processed; and, if no information about the terminal node exists in the result node of the direct link, storing information about a terminal node, to which an object will belong, in a result node of the buffer and the result node of the direct link through a search in the R-tree.

Preferably, the delete operation step may comprise the steps of, if information about a terminal node exists in a result node of a direct link, storing information about a terminal node, to be deleted, in a result node of the buffer and the result node of the direct link through a search in the R-tree; and, if no information about the terminal node exists in the result node of the direct link, returning a value indicating failure as a result of the operation, and then considering the operation to have been processed.

Preferably, the update operation step may comprise the steps of, if information about a terminal node exists in a result node of the direct link, obtaining a value indicating failure as a result of the operation, and considering the operation to have been processed; and, if no information about the terminal node exists in the result node of the direct link, removing the update operation from the buffer, separating the update operation into a delete operation and an insert operation, acquiring operation information depending on the delete operation and the insert operation, and storing the operation information in the buffer.

Preferably, the third step may be performed so that, if a plurality of operations for a single object exists in a predetermined period, effectiveness of the operations is determined depending on an input sequence thereof on the basis of whether a corresponding object exists in the direct link, effective operations apply information about a terminal node, to be applied as a result of the operations, to the direct link, and do not change a corresponding buffer, and obsolete operations indicate a false state as a result value thereof, without changing the direct link, and change an IsProcess field of the corresponding buffer to a true state, thus indicating that the operations have been performed.

Preferably, the fourth step may be performed so that the number of insert operations and the number of delete operations are counted for each terminal node to obtain variation in the number of empty spaces in the node, and the variation is decreased in steps of 1 in the insert operations because the number of empty spaces in the node is decreased, and the variation is increased in steps of 1 in the delete operations because the number of empty spaces in the node is increased.

Preferably, the fifth step may be performed so that information about empty spaces of a corresponding terminal node, which is obtained from a leaf node using variation in the number of empty spaces provided by the buffer, is used, all records stored in the buffer are examined, and the operations are performed according to an input sequence thereof in the case where the operations satisfy a processing condition.

Preferably, the buffer may be implemented so that half of a capacity of the buffer is used for a space for inputting queries, and a remaining half thereof is used for a record part for separating stored update queries and storing the separated queries.

Preferably, the record part may comprise an external input region, which is a region for inputting data from an outside, and an internal input region, which is a region for storing data through internal processing.

Preferably, the leaf node may comprise a node ID indicating an ID of a terminal node stored in the R-tree; a max entry indicating a maximum number of entries which the terminal node can have; a blank indicating a number of empty entries in the terminal node; and a node pointer indicating an address value pointing at the terminal node stored in the R-tree.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing an index structure according to an embodiment of the present invention;

FIG. 2A is a diagram showing the configuration of a buffer according to an embodiment of the present invention;

FIG. 2B is a diagram showing the format of the record of FIG. 2A;

FIG. 3 is a flowchart of the operating sequence of an algorithm showing a lazy bulk insertion method for moving object indexing according to the present invention; and

FIG. 4 is a flowchart showing the query refining and separating step of FIG. 3.

### DESCRIPTION OF THE PREFERRED EMBODIMENTS

Hereinafter, embodiments of the present invention will be described in detail with reference to the attached drawings.

Before the present invention is described in detail, it should be noted that detailed descriptions may be omitted if it is determined that the detailed descriptions of related well-known functions and construction may make the gist of the present invention unclear.

Before an algorithm showing the entire buffer processing procedure according to the present invention is described, the overall index structure for a lazy bulk insertion technique of the present invention is described.

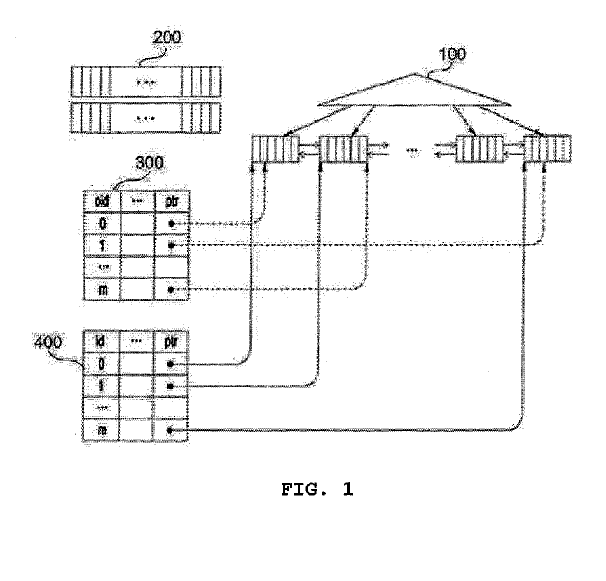

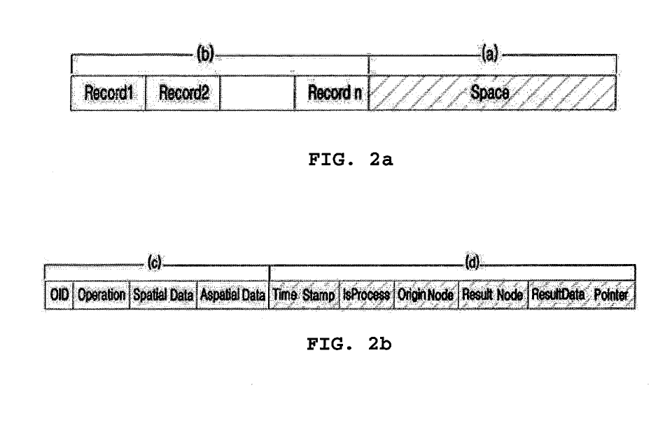

FIG. 1 is a diagram showing an index structure according to an embodiment of the present invention, FIG. 2A is a diagram showing the configuration of the buffer of a moving object indexing system according to the present invention, and FIG. 2B is a diagram showing the format of the record of FIG. 2A.

In the present invention, as shown in FIG. 1, showing the overall index structure for a lazy bulk insertion technique, a hash-based direct link 300 and a leaf node 400 are used to overcome the disadvantages of an R-tree 100, which is a spatial index structure, on the basis of the R-tree 100, and two buffers 200 are used to simultaneously store operations in the buffers and process the queries stored in the buffers.

Further, externally applied queries are stored in the buffers 200 together with timestamps, and are periodically simultaneously processed. In order to process the queries stored in the buffers 200, object information and information about terminal nodes related to corresponding objects are acquired from the direct link 300 and the leaf node 400, the correlation between the queries is analyzed on the basis of the acquired information, and thus the processing sequence of the queries is re-defined in order to reduce costs.

Furthermore, queries, the processing sequence of which has been changed, are processed through defined algorithms, respectively, depending on the type of query. Variation in information about objects or terminal nodes, occurring due to the processing of queries, is stored in the direct link 300 and the leaf node 400. The results of processing of queries are stored in a temporary storage space, and the location of the storage space is stored in a corresponding operation in the buffers. After all of the operations existing in the buffers are processed, the results of queries stored in the buffers are returned in a batch manner.

Further, each of the buffers 200 has two types of states, that is, an activated state, enabling the storage of input queries, and a deactivated state, enabling the processing of queries. The input queries are stored in an activated buffer. If more queries cannot be stored in the buffer, or if a query processing request is input by a scheduler, the state of the buffer is changed from the activated state to a deactivated state. The deactivated buffer does not store any more queries, and processes the stored queries. The present invention is implemented to simultaneously store and process queries using two buffers.

As shown in FIG. 2A, half of the capacity of the buffer is used for a space (a) for inputting queries, and the remaining half thereof is used for a space (b) for dividing stored update queries and storing the divided queries.

As shown in FIG. 2B, the record of each buffer can be divided into an external input region (c) for externally inputting data, and an internal input region (d) for storing data through internal processing.

The external input region (c) is composed of an Object Identifier (OID) field indicating a query-related object ID, an operation field indicating the type of query, and Spatial Data/Aspatial Data fields indicating spatial/aspatial data included in a query.

Furthermore, the region (d) determined by the internal module is composed of a TimeStamp field, indicating the input sequence of queries, an IsProcess field, indicating whether each operation has been processed, an OriginNode field, indicating information about the corresponding terminal node of an R-tree, to which a query-related object belongs, and a ResultNode field, indicating information about a result node, to which an object will belong, as the result of a query.

Further, as the initial value of the internal input region (d) of the record, the operation information of FIG. 2B must be recorded in an activated buffer when moving objects are collected in the buffer. The operation information includes information obtained from a query and a timestamp value. The timestamp is 0, 2, 4, . . . , 2n, that is, a multiple of 2, including 0, and has a sequentially increasing value. That is, in this technique, an update operation is separated into two operations, that is, a delete operation and an insert operation, and is processed thereby, so that such a timestamp is required to identify the sequential positions of respective operations. The separated insert operation is assigned a timestamp increasing by 1, compared to the timestamp of the delete operation, thus guaranteeing the same operation processing result as the result of the update operation.

Meanwhile, the direct link 300 is a structure for managing all moving objects stored in the R-tree 100. The direct link 300 uses the ID of each object as a key, and has information about the type of queries and the entry pointer of the terminal node to which a corresponding object belongs. Further, the direct link 300 has information about the terminal node to which a corresponding object belongs in the R-tree 100 before each query stored in the buffer is processed, and information about the terminal node to which a corresponding object will belong after the query is processed. Information about the terminal node stored in the origin node (OriginNode) is the information about a terminal node for a corresponding object, which a previous R-tree has before the query stored in the buffer is processed. Such information is updated to information about the terminal node to which the corresponding object of the varied R-tree belongs after all queries about the object have been processed. However, the result node (ResultNode) reflects varied items after each query stored in the buffer has been processed. The varied result node (ResultNode) is used as the criteria for determining the effectiveness of the query, which will be described later.

The leaf node 400 is a structure proposed to manage terminal nodes, and is a hash-based structure that uses respective terminal node IDs as keys, that has information about the maximum number of entries and the number of empty entries, which each terminal node has, and that has pointers, which point at corresponding terminal nodes, as records. The leaf node 400 manages information about the number of empty spaces in each terminal node, and provides empty space information to predict the modification of the terminal node caused by an update operation.

Hereinafter, a method of indexing moving objects according to the present invention is described in detail.

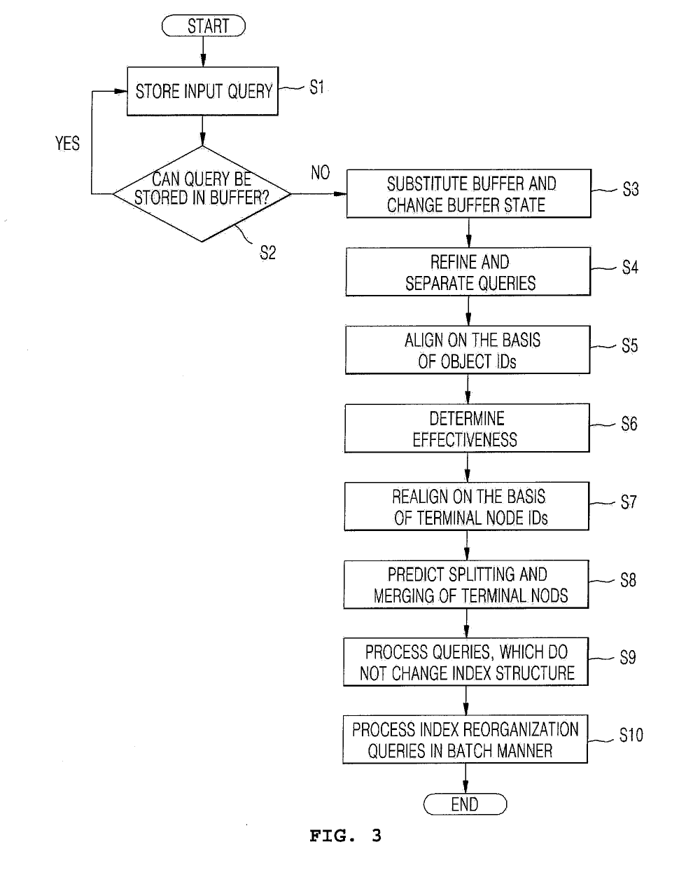

FIG. 3 is a flowchart of an algorithm showing a method of indexing moving objects according to the present invention.

First, when a query input at step S1 cannot be stored in a buffer at step S2, the buffer is substituted with the other one, and the state thereof is changed to an activated state at step S3.

Then, the query refining and separating step S4 of sequentially analyzing the operations stored in the deactivated buffer, obtaining information about objects corresponding to respective operations from a direct link so as to analyze the operations, and aligning the obtained information on the basis of object IDs is performed.

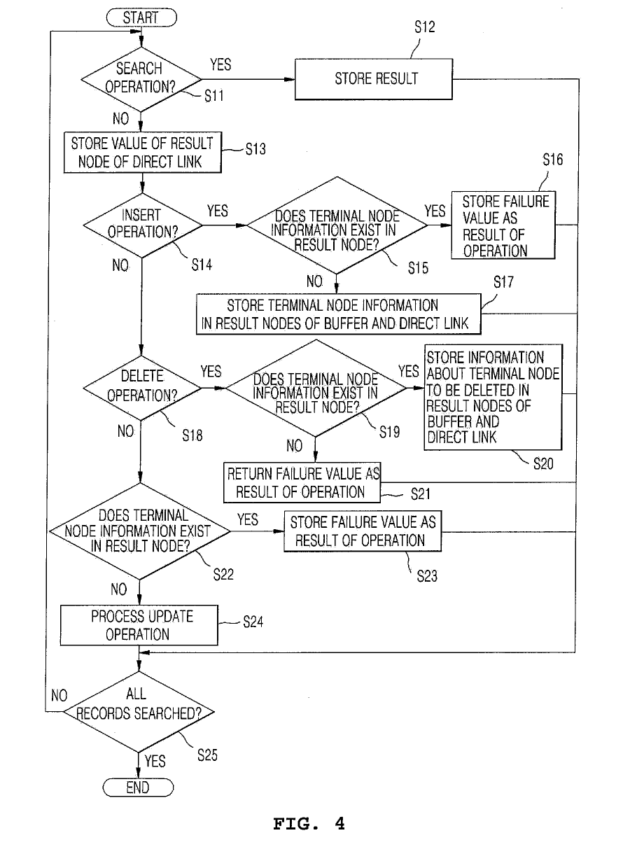

The query refining and separating step S4 is now described in detail. As shown in FIG. 4, at the query refining and separating step S4, a search operation step, an insert operation step, a delete operation step and an update operation step are performed.

The search operation step S11 indicates that the corresponding operation has been processed by changing the state of each IsProcess field to a true state for all processed operations, without changing the values of the origin node (OriginNode) and the result node (ResultNode) of the buffer from initial values thereof. Further, result values are stored in a temporary storage space, and can be accessed through the buffer. In the case of the search operation, all operations are processed during a refining procedure, and result values are stored in the buffer at step S12. Furthermore, in cases other than the search operation, the value of the result node of the direct link is stored at step S13.

Further, the insert operation step S14 is performed to determine whether information about a terminal node exists in the result node of the direct link at step S15. If the terminal node information is found to exist in the result node, a value indicating failure is stored as the result of the operation, and the operation is considered to have been processed at step S16. If the terminal node information is found not to exist in the result node of the direct link, information about the terminal node to which the object will belong is stored in the result node of the buffer and the result node of the direct link through the search in the R-tree at step S17.

In contrast, the delete operation step S18 is performed to determine whether information about a terminal node exists in the result node at step S19. If the terminal node information is found to exist, information about the terminal node from which an object is deleted is stored in the result node of the buffer and the result node of the direct link at step S20. If the terminal node information is found not to exist, a value indicating failure is returned as the result of the operation, and then the operation is considered to have been processed at step S21. Furthermore, in cases other than the delete operation, whether the terminal node information exists in the result node is determined at step S22. If the terminal node information is found to exist, a value indicating failure is stored as the result of the operation at step S23, whereas, if the terminal node information is found not to exist, the process proceeds to an update operation step.

The update operation step S24 is performed so that, if information about a terminal node is found to exist in the result node of the direct link, a value indicating failure is stored as the result of the operation, and thus the operation is considered to have been processed at step S24, similar to the insert operation. However, if information about the terminal node is found not to exist in the result node of the direct link, the update operation is removed from the buffer and is separated into a delete operation and an insert operation, and, accordingly, operation information is obtained depending on the above-described delete and insert operations, and is stored in the buffer.

In this case, the value of a timestamp stored in a delete operation is identical to the timestamp value of an update operation to be deleted, and the value of a timestamp stored in an insert operation is obtained by adding 1 to the timestamp value of the delete operation Since the operations have different timestamp values, they can be separately processed, thus the processing sequence of the operations can be guaranteed.

If the search in all records has been completed at step S25, the query refining and separating step is terminated. Thereafter, information about objects corresponding to respective operations is obtained and is aligned on the basis of object IDs at step S5. The step S6 of identifying the operations, aligned in ascending order of spatial objects depending on respective objects, and determining the effectiveness of the operations is started. Hereinafter, this procedure is described in detail.

If a first operation for a corresponding object is an insert operation when no object exists in a direct link, or if a first operation for a corresponding object is a delete operation when the object exists in the direct link, the corresponding operation is identified as an effective operation. However, an insert operation appearing when an object exists or a delete operation appearing when no object exists is identified as an obsolete operation.

Further, effective operations apply information about a terminal node, to be applied as the result of the operations, to the direct link, but do not change a corresponding buffer. In the case of an obsolete operation, the result value thereof indicates a false state without changing the direct link, and the IsProcess field of the corresponding buffer is changed to a true state, thus indicating that the corresponding operation has been performed.

If such an effectiveness determining step has been terminated, the operations are realigned on the basis of terminal node IDs at step S7, and the step of predicting the splitting and merging of terminal nodes is performed.

The step S8 of predicting the splitting and merging of the terminal nodes is described. First, the number of insert operations and the number of delete operations are counted for each terminal node, so that variation in the number of empty spaces in the node is obtained. In the case of an insert operation, since the number of empty spaces in the node decreases, variation is decreased in steps of 1. In contrast, in the case of a delete operation, since the number of empty spaces increases, variation is increased in steps of 1. The variation in the number of empty spaces obtained in this procedure is used to change the processing sequence of operations in order to reduce indexing costs, together with the information about the corresponding terminal node.

Next, the step S9 of processing queries which do not change an index structure is started.

In order to find operations that do not result in modifications of nodes, information about empty spaces of a corresponding terminal node, which is obtained from the leaf node on the basis of the variation in the number of empty spaces provided by the buffer, is used together.

When all of the records in the buffer are examined, and an operation satisfying a processing condition is detected, the corresponding operation is performed until the variation in the number of empty spaces, obtained from the buffer, becomes identical to variation in the number of empty spaces in a current terminal node. In order to process an insert operation, empty spaces must exist in the corresponding terminal node. In order to process a delete operation, entries having a certain or higher percentage must exist in the terminal node. The operations satisfying such conditions are immediately performed regardless of the input sequence of the operations. That is, index reorganization queries, remaining after the maximum number of queries, which do not cause splitting and merging, have been detected and processed, are processed in a batch manner at step S10.

In a conventional technique, since processing of operations without considering the input sequence of operations cannot guarantee the success of the operations, it is not permitted. However, since the reorganization of the sequence of operation processing proposed in lazy bulk insertion guarantees only a single effective operation for each moving object, respective operations have independent properties, thus guaranteeing the results of operation processing.

Therefore, a lazy bulk insertion method for moving object indexing according to the present invention is advantageous in that it utilizes a hash-based data structure to overcome the disadvantages of an R-tree, that is, a representative spatial index structure, and uses two buffers to simultaneously store operations in the buffers and process queries stored in the buffers, so that the overall update cost can be reduced, and in that it utilizes a buffer structure to process data about moving objects in a batch manner, so that all input queries about moving objects can be stored and managed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A lazy bulk insertion method for a moving object indexing method based on an R-tree, comprising:
a first step of substituting a buffer and changing a state of the buffer to a deactivated state if an input query cannot be stored in the buffer;
a second step of sequentially analyzing operations stored in the deactivated buffer, obtaining information about objects corresponding to respective operations from a direct link to analyze the operations, and thus aligning the operations on the basis of object IDs;
a third step of identifying operations, aligned in ascending order of spatial objects, depending on respective objects, determining effectiveness of the operations, and thus realigning the operations on the basis of terminal node IDs;
a fourth step of counting a number of insert operations and a number of delete operations for each terminal node, and obtaining variation in a number of empty spaces in the terminal node, thus predicting splitting and merging of the terminal nodes; and
a fifth step of reorganizing a processing sequence of queries so as to reduce variation in the node on the basis of the predicted information.

2. The lazy bulk insertion method according to claim 1, wherein the second step comprises a search operation step, an insert operation step, a delete operation step, and an update operation step.

3. The lazy bulk insertion method according to claim 2, wherein the search operation step is performed so that values of an origin node and a result node are processed without being changed from initial values thereof, and result values of the processing are stored in the buffer.

4. The lazy bulk insertion method according to claim 2, wherein the insert operation step comprises the steps of:
if information about a terminal node exists in a result node of a direct link, obtaining a value indicating failure as a result of the operation, and considering the operation to have been processed; and
if no information about the terminal node exists in the result node of the direct link, storing information about a terminal node, to which an object will belong, in a result node of the buffer and the result node of the direct link through a search in the R-tree.

5. The lazy bulk insertion method according to claim 2, wherein the delete operation step comprises the steps of:
if information about a terminal node exists in a result node of a direct link, storing information about a terminal node, to be deleted, in a result node of the buffer and the result node of the direct link through a search in the R-tree; and
if no information about the terminal node exists in the result node of the direct link, returning a value indicating failure as a result of the operation, and then considering the operation to have been processed.

6. The lazy bulk insertion method according to claim 2, wherein the update operation step comprises the steps of:
if information about a terminal node exists in a result node of the direct link, obtaining a value indicating failure as a result of the operation, and considering the operation to have been processed; and
if no information about the terminal node exists in the result node of the direct link, removing the update operation from the buffer, separating the update operation into a delete operation and an insert operation, acquiring operation information depending on the delete operation and the insert operation, and storing the operation information in the buffer.

7. The lazy bulk insertion method according to claim 1, wherein the third step is performed so that, if a plurality of operations for a single object exists in a predetermined period, effectiveness of the operations is determined depending on an input sequence thereof on the basis of whether a corresponding object exists in the direct link, effective operations apply information about a terminal node, to be applied as a result of the operations, to the direct link, and do not change a corresponding buffer, and obsolete operations indicate a false state as a result value thereof, without changing the direct link, and change an IsProcess field of the corresponding buffer to a true state, thus indicating that the operations have been performed.

8. The lazy bulk insertion method according to claim 1, wherein the fourth step is performed so that the number of insert operations and the number of delete operations are counted for each terminal node to obtain variation in the number of empty spaces in the node, and the variation is decreased in steps of 1 in the insert operations because the number of empty spaces in the node is decreased, and the variation is increased in steps of 1 in the delete operations because the number of empty spaces in the node is increased.

9. The lazy bulk insertion method according to claim 1, wherein the fifth step is performed so that information about empty spaces of a corresponding terminal node, which is obtained from a leaf node using variation in the number of empty spaces provided by the buffer, is used, all records stored in the buffer are examined, and the operations are performed according to an input sequence thereof in the case where the operations satisfy a processing condition.

10. The lazy bulk insertion method according to claim 1, wherein the buffer is implemented so that half of a capacity of the buffer is used for a space for inputting queries, and a remaining half thereof is used for a record part for separating stored update queries and storing the separated queries.

11. The lazy bulk insertion method according to claim 10, wherein the record part comprises an external input region, which is a region for inputting data from an outside, and an internal input region, which is a region for storing data through internal processing.

12. The lazy bulk insertion method according to claim 9, wherein the leaf node comprises:
a node ID indicating an ID of a terminal node stored in the R-tree;
a max entry indicating a maximum number of entries which the terminal node can have;
a blank indicating a number of empty entries in the terminal node; and
a node pointer indicating an address value pointing at the terminal node stored in the R-tree.
